(19) United States
(12) Patent Application Publication
(10) Pub. No.: US 2001/0027152 A1
(43) Pub. Date: Oct. 4, 2001

(54) Machining centers

(76) Inventor: Giuseppe Bolledi, Ponte dell'Olio (IT)

Correspondence Address: WENDEROTH, LIND & PONACK, L.L.P., 2033 K STREET N. W., SUITE 800, WASHINGTON, DC, 20006-1021, US

(21) Appl. No.: 09/818,897

(22) Filed: Mar. 28, 2001

(30) Foreign Application Priority Data
Mar. 28, 2000 (IT) MI2000U 000189

(51) Int. Cl. B23Q 3/157; B23C 1/02

(52) U.S. Cl. 483/14; 483/30; 483/63; 409/159; 409/160

(57) ABSTRACT

The machining center has a base, a frame and at least a machine tool mounted onto the frame, at least a tool magazine associated with the machine tool for changing the tool and a workpiece gripping and supporting member. The machining center comprises a movable vertical member adapted to support from the top the workpiece gripping and supporting member. The movable vertical member is adapted to position the workpiece gripping and supporting member in a first operative position in which the workpiece is automatically loaded onto or unloaded from the workpiece gripping and supporting member of the machining center and in a second operative position in which the workpiece is machined by the machine tool of the machining center. The gripping and supporting member is adapted to hold firmly the workpiece during the machining operation and support it from the top so that the chips formed by the machine tool during the machining operation fall downwards by force of gravity thereby clearing the machining area from the chips.

### BACKGROUND OF THE INVENTION

The present invention generally relates to the field of machine tools and particularly a machining center having an improved configuration including a novel device for loading and supporting a workpiece during machining operation.

### DESCRIPTION OF THE PRIOR ART

It is known that the machining centers are commonly included in machining systems comprising a plurality of machining centers which are coordinated by a central control unit. The workpieces are fed to the single machining centers and transferred from one machining center to another by means of transporting means arranged near the machining centers and formed of movable pallets. In conventional machining systems there is provided a device for loading a workpiece in the machining center which is formed of a manipulator arm connected to the machining center. This configuration of the conventional machining centers is rather complex from both a structural and operative point of view.

### SUMMARY OF THE INVENTION

An object of the present invention is to obviate the above disadvantage of conventional machining centers by providing a machining center having a configuration which does not require a manipulator arm to perform the loading and unloading operations of the workpiece into and from the machining center. More particularly, the machining center is of the kind having a base, a frame, at least a machine tool mounted onto the frame, at least a tool magazine associated with said machine tool for changing the tool and a workpiece gripping and supporting member, wherein said machining center comprises:

a movable vertical member adapted to support from the top the workpiece gripping and supporting member, said movable vertical member being adapted to position the workpiece gripping and supporting member in a first operative position in which the workpiece is automatically loaded onto or unloaded from the workpiece gripping and supporting member of the machining center and in a second operative position in which the workpiece is machined by the machine tool of the machining center;

said gripping and supporting member being adapted to hold firmly the workpiece during the machining operation and support said workpiece from the top so that the chips formed by the machine tool during the machining operation fall downwards by force of gravity thereby clearing the machining area from the chips.

### BRIEF DESCRIPTION OF THE DRAWINGS

FIG. 1 is a perspective view of the machining center according to the present invention;

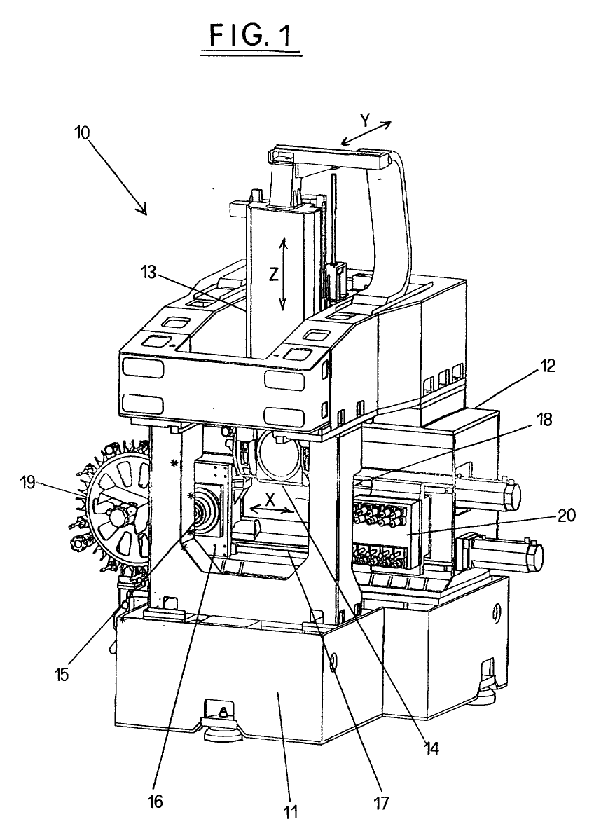

FIG. 2 is a side elevation view of the machining center according to the present invention; and

FIG. 3 is a side elevation view of the machining center showing the detail of the workpiece gripping and supporting member.

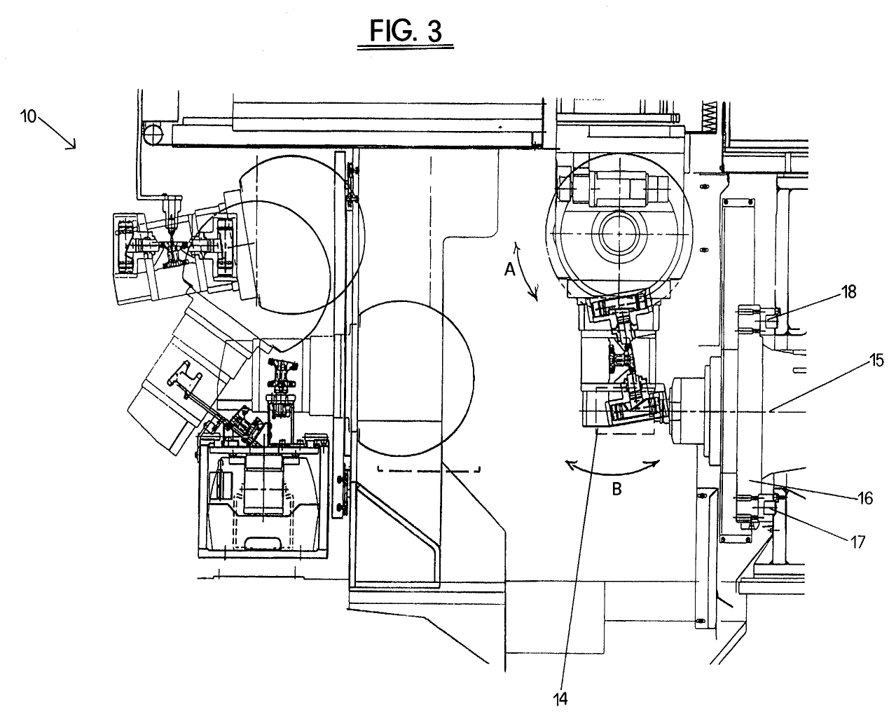

### DESCRIPTION OF THE PREFERRED EMBODIMENT

Referring to the Figures of the drawings there is shown the machining center according to the present invention, generally designated by 10. The machining center 10 comprises a base 11, a frame 12 and a movable vertical member 13 at the lower end of which a workpiece gripping and supporting member 14 is connected.

The workpiece gripping and supporting member 14 is connected to the lower end of the movable vertical member 13 which is movable along an horizontal axis Y and a vertical axis Z. Furthermore, the workpiece gripping and supporting member 14 is provided with two rotation axes designated by A and B.

The machining center 10 also includes a machine tool 15 with an horizontal spindle mounted onto a slide 16 which is movable on guides 17,18 along an horizontal axis X. The machining center 10 is also provided with at least a pair of tool magazines 19,20, one of which 19 is of a rotary type, and the other 20 is of the rack type. The pair of tool magazines 19,20 are located at the left and right limit stops of the slide 16 of the machine tool 15, respectively.

Near the machining center 10 is located a workpiece transporter means formed of a movable pallet (not shown) which can be positioned in front of the machining center 10 during the loading and unloading operations of the workpiece onto and from the workpiece gripping and supporting member 14. To this purpose, the movable vertical member 13 carries the workpiece gripping and supporting member 14 to the pallet so as to permit it to grip the workpiece and position it in the machining area.

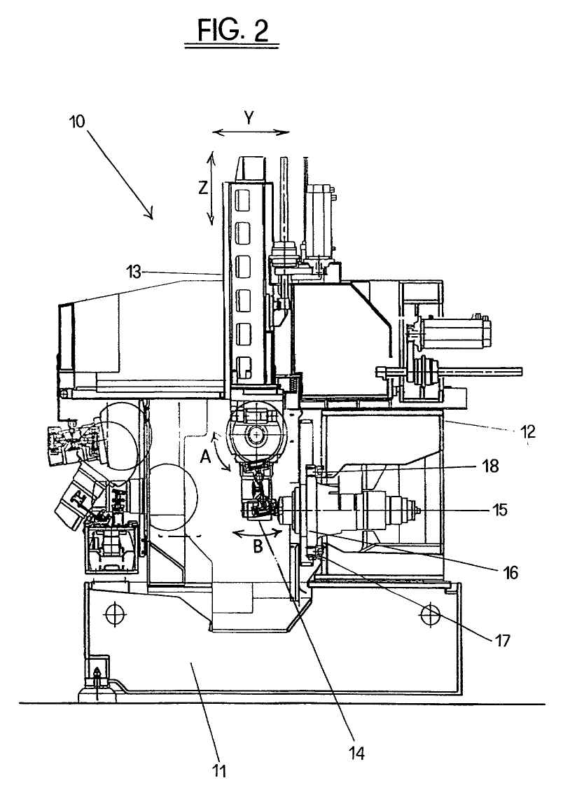

As can be seen in particular in FIG. 2, the workpiece is supported from the top by means of the workpiece gripping and supporting member 14. During the machining operation the movement of the workpiece gripping and supporting member 14 with respect to the spindle of the machine tool 15 is controlled by a conventional machining center numerical control so as to carry out a predetermined machining task.

As can be seen, the configuration of the machining center according to the present invention, does not require a manipulator arm for the loading and unloading operations of the workpiece onto and from the workpiece gripping and supporting member 14 because this operation is accomplished by the movable vertical member 13 which carries the workpiece gripping and supporting member 14. The workpiece gripping and supporting member 14 has both the task of loading/unloading the workpiece and supporting it during the machining operation. Furthermore, the workpiece gripping and supporting member 14 is connected to the movable vertical member 13 so as to always support the workpiece from the top, thus avoiding the use of a special device for removing the chips formed during the machining operation from the machining area since the chips fall downwards by force of gravity thereby clearing the machining area therefrom.

From the foregoing it can be understood that the machining center according to the present invention achieves the aimed object. In particular, the machining center has the advantage of not requiring a special manipulator arm for loading and unloading the workpiece into and from the machining center. As a matter of fact, this operation is carried out by the movable vertical member 13 with the workpiece gripping and supporting member 14, thereby increasing productivity and flexibility of the machining center. The workpiece gripping and supporting member 14 is attached to the lower end of the movable vertical member 13 which is connected to the frame of the machining center 10. Therefore, the workpiece gripping and supporting member 14 supports the workpiece from the top thus permitting the machining area to be cleared of the chips formed during the machining operation without requiring a special device for this purpose, but simply using the force of gravity since the chips fall down during the machining operation. The structure of the machining center according to the present invention permits a more simple workpiece loading/unloading operation to be achieved.

What is claimed is:

1. A machining center having a base, a frame and at least a machine tool mounted onto the frame, at least a tool magazine associated with said machine tool for changing the tool and a workpiece gripping and supporting member, wherein said machining center comprises:
a movable vertical member adapted to support from the top the workpiece gripping and supporting member, said movable vertical member being adapted to position the workpiece gripping and supporting member in a first operative position in which the workpiece is automatically loaded onto or unloaded from the workpiece gripping and supporting member of the machining center and in a second operative position in which the workpiece is machined by the machine tool of the machining center;
said gripping and supporting member being adapted to hold firmly the workpiece during the machining operation and support said workpiece from the top so that the chips formed by the machine tool during the machining operation fall downwards by force of gravity thereby clearing the machining area from the chips.

2. A machining center according to claim 1, wherein said vertical member to which the workpiece gripping and supporting member is attached is movable along an horizontal axis and a vertical axis.

3. A machining center according to claim 1, wherein said workpiece gripping and supporting member is capable of rotating about an horizontal axis and a vertical axis.

4. A machining center according to claim 1, wherein said machine tool is mounted onto a slide which is movable along an horizontal axis perpendicular to the axes of movement of said movable vertical member.

5. A machining center according to claim 1, wherein a pair of tool magazines are provided which are associated to the machine tool and are located at the left and right limit stops thereof.

6. A machining center according to claim 5, wherein at least one of said tool magazines is of the rotary type.

7. A machining center according to claim 5, wherein at least one of said tool magazines is of the rack type.
